(19) United States
(12) Patent Application Publication
(10) Pub. No.: US 2026/0302967 A1
(43) Pub. Date: Oct. 1, 2026

(54) MODULAR MULTILEVEL CONVERTER

(71) Applicant: Delta Electronics, Inc., Taipei (TW)

(72) Inventors: Ruxi WANG, Morrisville, NC (US); Peter Mantovanelli BARBOSA, Taoyuan City (TW); Dihao MA, Morrisville, NC (US); Jian LIU, Morrisville, NC (US)

(73) Assignee: Delta Electronics, Inc., Taipei (TW)

(21) Appl. No.: 19/577,595

(22) Filed: Mar. 25, 2026

Related U.S. Application Data
(60) Provisional application No. 63/777,109, filed on Mar. 25, 2025.

(51) Int. Cl. H02M 7/483; H02M 1/00; H02M 7/5387

(52) U.S. Cl. CPC H02M 7/483; H02M 1/0003; H02M 7/53871

(57) ABSTRACT

A modular multilevel converter includes a phase leg including a upper arm and a lower arm connected in series, wherein the upper arm includes a plurality of arms connected in parallel, wherein one of the arms includes a chain link and an arm inductor connected in series, wherein the chain link includes a plurality of submodules connected in series, and wherein each submodule includes a half-bridge circuit or a full-bridge circuit; and a control module connected to the plurality of submodules, wherein the control module is configured to provide a voltage reference value for each arm by combining a common mode voltage reference value for all of the arms and a differential mode voltage reference value for each arm.

### RELATED APPLICATION

This application claims the benefit of priority of U.S. Provisional Patent Application No. 63/777,109, filed on Mar. 25, 2025, the contents of which are all incorporated by reference herein in their entirety.

### FIELD

The disclosure relates to the current scalability of the modular multilevel converter through a simple arm parallel connection. This method does not impact on the original design of the submodule (SM), so the system modularity could be enhanced. Moreover, the disclosure relates to the current sharing control and interleaved modulation methods for the parallelled arms, which can further improve the current quality.

### BACKGROUND

A modular converter demonstrates excellent scalability and modularity, thus widely applied in many medium/high-voltage applications, such as the modular multilevel converter (MMC). The traditional MMC shows voltage scalability, because it can be applied to any voltage class by changing the SM number. However, for a certain fixed voltage rating, an increase in MMC power rating implies higher current capacity. The remaining challenges are the current sharing and energy balancing among the arms.

### SUMMARY

The purpose of the disclosure is to provide a current capacity scalable modular multilevel converter using parallel connected arms.

Specifically, the disclosure is related to close-loop control of current sharing and energy balancing control among the parallel arms. Two kinds of methods are proposed, and the first one uses two separated current loops with one extra balancing component to the arm voltage reference. The second method uses the circulating current among parallel arms to balance the energy.

The disclosure is also related to interleaved modulation stage among parallel arms. Both the carrier-based modulation and sorting-based modulation strategies are proposed. In this way, the switching-frequency harmonics of the total arm current could be reduced. The total current quality could be improved.

Furthermore, the coupled arm inductors can be applied to the parallel arms to optimize the total volume of arm inductors.

One embodiment of the disclosure provides a modular multilevel converter, including: a phase leg including a upper arm and a lower arm connected in series, wherein the upper arm includes a plurality of arms connected in parallel, wherein one of the arms includes a chain link and an arm inductor connected in series, wherein the chain link includes a plurality of submodules connected in series, and wherein each submodule includes a half-bridge circuit or a full-bridge circuit; and a control module connected to the plurality of submodules, wherein the control module is configured to provide a voltage reference value for each arm by combining a common mode voltage reference value for all of the arms and a differential mode voltage reference value for each arm.

Optionally, the differential mode voltage reference value for each arm is obtained from an output of a current loop combining a differential mode current component of each arm and a differential mode current reference value for each arm.

Optionally, the differential mode current reference value for each arm is obtained from an output of a proportional-integral (PI) controller.

Optionally, the control module further includes a parallel energy balancing block configured to provide a differential mode voltage component of each arm to the PI controller.

Optionally, the common mode voltage reference value is obtained from an output of a current loop inputting a current reference value of the upper arm.

One embodiment of the disclosure further provides a modular multilevel converter, including: a phase leg including a upper arm and a lower arm connected in series, wherein the upper arm includes a plurality of arms connected in parallel, wherein one of the arms includes a chain link and an arm inductor connected in series, wherein the chain link includes a plurality of submodules connected in series, wherein each submodule includes a half-bridge circuit or a full-bridge circuit; and a control module connected to the plurality of submodules, wherein the control module is configured to provide a voltage reference value for each arm from an output of a current loop inputting a current reference value for each arm.

Optionally, the current reference value for each arm is obtained by combining a common mode current reference value for each arm and a differential mode current reference value for each arm.

Optionally, the differential mode current reference value for each arm is obtained from an output of a proportional-integral (PI) controller.

Optionally, the control module further includes a parallel energy balancing block configured to provide a differential mode voltage component of each arm to the PI controller.

Optionally, the common mode current reference value for each arm is obtained by dividing a current reference value of the upper arm with a number of the arms in the upper arm.

One embodiment of the disclosure further provides a modular multilevel converter, including: a phase leg including a upper arm and a lower arm connected in series, wherein the upper arm includes a plurality of arms connected in parallel, wherein one of the arms includes a chain link and an arm inductor connected in series, wherein the chain link includes a plurality of submodules connected in series, wherein each submodule includes a half-bridge circuit or a full-bridge circuit; and a control module connected to the plurality of submodules, wherein the control module is modulated by a phase-shift method that carrier phases of submodules in the arm are interleaving, and carrier phases of arms are interleaving.

Optionally, a capacitor voltage reference value for each submodule in one of the arms is provided to the phase-shift method to determine which submodule is bypassed.

Optionally, the capacitor voltage reference value for each submodule in one of the arms is obtained by combining a common mode capacitor voltage reference value and differential mode capacitor voltage reference value for each submodule in one of the arms.

Optionally, number of the plurality of arms connected in parallel is m, number of the submodule in the arm is N, a carrier phase-shift angle of N submodules in the arm is defined as 2π/N, and a carrier phase-shift angle of m parallel arms is defined as 2π/mN.

One embodiment of the disclosure further provides a modular multilevel converter, including: a phase leg including a upper arm and a lower arm connected in series, wherein the upper arm includes a plurality of arms connected in parallel, wherein one of the arms includes a chain link and an arm inductor connected in series, wherein the chain link includes a plurality of submodules connected in series, wherein each submodule includes a half-bridge circuit or a full-bridge circuit; and a control module connected to the plurality of submodules, wherein the control module is modulated by a level-shift method.

Optionally, a capacitor voltage reference value for each submodule is provided to the phase-shift method to determine which submodule is bypassed.

Optionally, number of the plurality of arms connected in parallel is m, number of the submodule in the arm is N, a carrier phase-shift angle of m parallel arms is defined as 2π/m.

Optionally, the control module is configured that carrier phases of arms are interleaving.

One embodiment of the disclosure further provides a modular multilevel converter, including: a phase leg including a upper arm and a lower arm connected in series, wherein the upper arm includes a plurality of arms connected in parallel, wherein each of the arms includes a chain link and an arm inductor connected in series, wherein the chain link includes a plurality of submodules connected in series, wherein each submodule includes a half-bridge circuit or a full-bridge circuit, and wherein the arm inductors of each arm connected in parallel are coupling to each other.

One embodiment of the disclosure further provides a modular multilevel converter according to any one of abovementioned embodiments, wherein the arm inductors of each arm connected in parallel are coupling to each other.

Compared to prior art, the parallel arms of the disclosure can reuse available SM design so that the power scaling of the MMC gets substantially facilitated. The control module of the embodiment of the disclosure provides close-loop control of current sharing and energy balancing control among the parallel arms. The SM capacitor voltages of the parallel arms are balanced as well. Further, the modulation stage of parallel arms could be interleaved to improve the current quality. Switching frequency harmonics in the total arm current are reduced a lot. Moreover, the coupled arm inductors of the embodiment of the disclosure optimize the total volume of arm inductors.

### BRIEF DESCRIPTION OF THE SEVERAL VIEWS OF THE DRAWINGS

FIG. 1A is a schematic illustration of a three-phase modular multilevel converter (MMC) according to an embodiment of the disclosure.

FIG. 1B illustrates two typical SM topologies of HB and FB according to an embodiment of the disclosure.

FIG. 2 illustrates the current scaling of MMC through parallel-connected arms according to an embodiment of the disclosure.

FIG. 3A is a schematic representation of the simplified model of three parallel arms according to an embodiment of the disclosure.

FIG. 3B is a schematic representation of the simplified model of three parallel arms with different voltage components according to an embodiment of the disclosure.

FIG. 3C is a diagram illustration of the common-mode simplified model of three parallel arms according to an embodiment of the disclosure.

FIG. 3D is a diagram illustration of the circulating simplified model of three parallel arms according to an embodiment of the disclosure.

FIG. 4A illustrates the energy balancing and current sharing control method of parallel arms through separated current loops according to an embodiment of the disclosure.

FIG. 4B illustrates the energy balancing and current sharing control method of parallel arms through a common current loop according to an embodiment of the disclosure.

FIG. 5A is a diagram illustration of the phase-shift carrier-based modulation method for parallel arms according to an embodiment of the disclosure.

FIG. 5B is a diagram illustration of the interleaved carrier waveform according to an embodiment of the disclosure.

FIG. 6A is a diagram illustration of the level-shift sorting-based modulation method for parallel arms according to an embodiment of the disclosure.

FIG. 6B is a diagram illustration of the interleaved level-shift carrier waveform according to an embodiment of the disclosure.

FIG. 7A is the simulation waveforms of MMC with only one arm according to an embodiment of the disclosure.

FIG. 7B is the simulation waveforms of MMC with three parallel arms and the proposed energy control balancing method and interleaved modulation strategy according to an embodiment of the disclosure.

FIG. 8 is a diagram illustration of three parallel arms with coupled inductors according to an embodiment of the disclosure.

### DETAILED DESCRIPTION

In order to make the above and other objects, features, and advantages of the disclosure easier to understand, preferred embodiments of the disclosure will be illustrated below and described in detail with reference to the drawings. In addition, in the drawings, structurally similar units are represented by the same reference numerals.

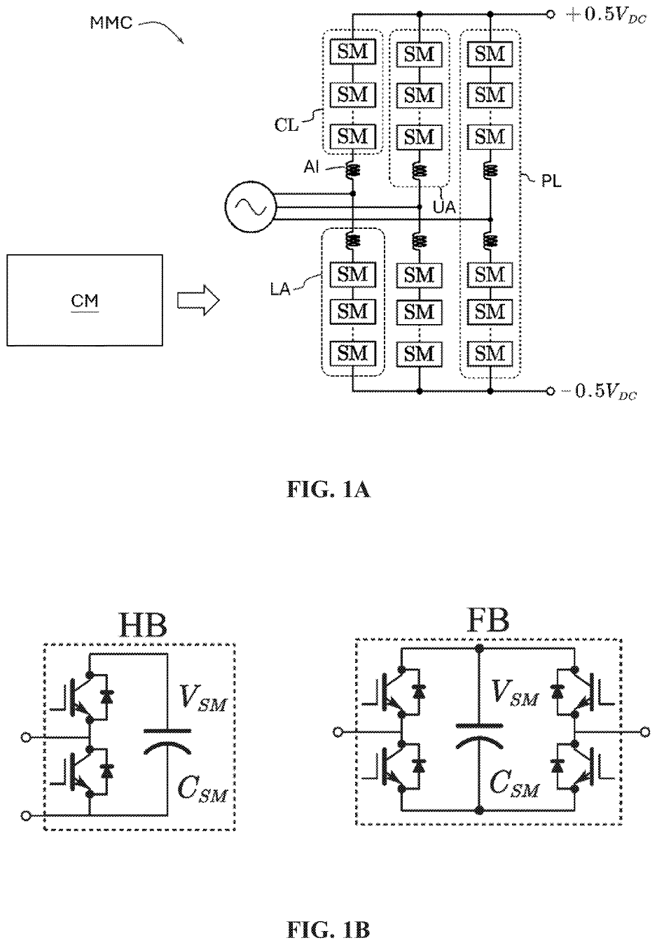

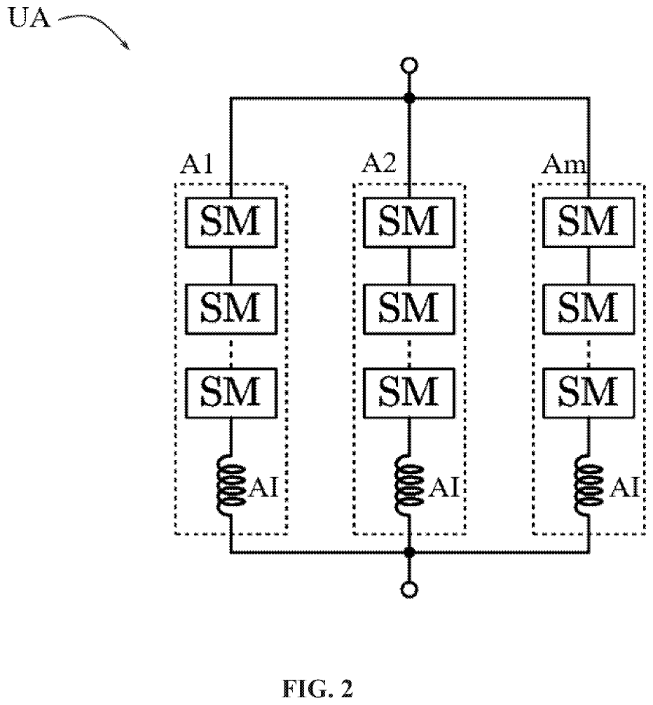

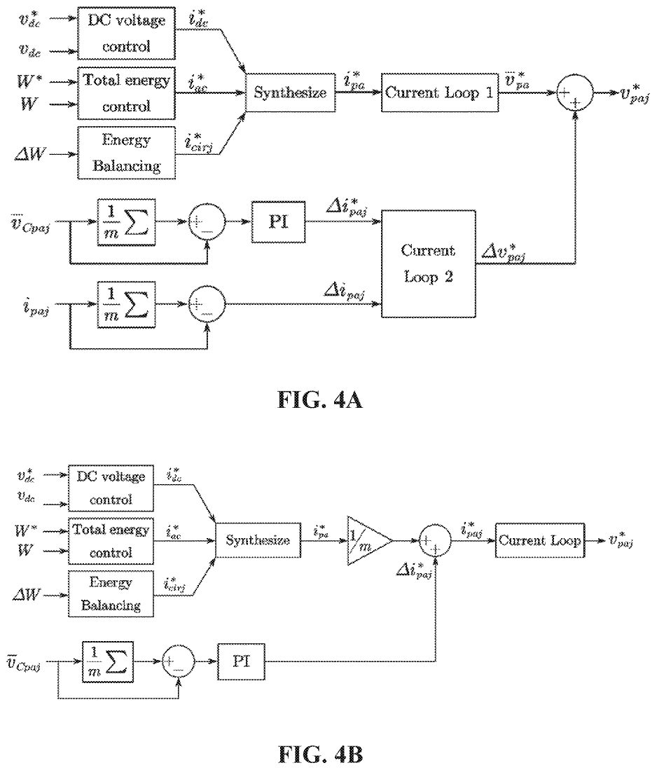

Referring to FIG. 1A, FIG. 1B, FIG. 2, and FIG. 4A, FIG. 1A is a schematic illustration of a three-phase modular multilevel converter (MMC) according to an embodiment of the disclosure. FIG. 1B illustrates two typical submodule SM topologies of half-bridge HB circuit and full-bridge FB circuit according to an embodiment of the disclosure. FIG. 2 illustrates the current scaling of MMC through parallel-connected arms according to an embodiment of the disclosure. FIG. 4A illustrates the energy balancing and current sharing control method of parallel arms through separated current loops according to an embodiment of the disclosure. One embodiment of the disclosure provides a modular multilevel converter MMC, including: a phase leg PL including a upper arm UA and a lower arm LA connected in series, wherein the upper arm UA includes a plurality of arms A1 to Am connected in parallel (referring to FIG. 2 for arms in parallel, FIG. 1A shows only one arm for simplicity), wherein one of the arms A1 to Am includes a chain link CL and an arm inductor AI connected in series, wherein the chain link CL includes a plurality of submodules SM connected in series, and wherein each submodule SM includes a half-bridge circuit HB or a full-bridge circuit FB (referring to FIG. 1B); and a control module CM connected to the plurality of submodules SM, wherein the control module CM is configured to provide a voltage reference value υₚₐⱼ* for each arm by combining a common mode voltage reference value υ̅ₚₐ* for all of the arms and a differential mode voltage reference value Δυₚₐⱼ* for each arm (referring to FIG. 4A).

FIG. 1A demonstrates the schematic of modular multilevel converter MMC. The modular multilevel converter MMC contains six power converter arms (upper arms UA or lower arms LA). Each power converter arm includes one arm inductor AI and one chain link CL. The chain link CL is made up of the series connected submodules SM, such as half-bridge circuit HB or a full-bridge circuit FB in FIG. 1B.

Modular converters demonstrate excellent scalability and modularity and can be applied in medium/high voltage applications. The modular multilevel converter MMC in FIG. 1A may be used in the high voltage direct current transmission. The modular structure also enables “N+1” redundancy for better system-level reliability.

Depending on the applications, the submodule SM topologies of the embodiments could be half bridge HB or full bridge FB in FIG. 1B. As shown in FIG. 1A, the chain link CL includes series-connected submodule SM, while a chain link CL in series connection of an arm inductor AI is referred to as the upper arm UA or the lower arm LA. Then the upper arm UA in series connection of the lower arm LA is referred to as one phase leg PL.

The modular multilevel converter MMC shows voltage scalability, because it can be applied to any voltage class by changing the SM number. However, for a certain fixed voltage rating, an increase in modular multilevel converter MMC power rating implies higher current capacity. Typical examples include power transmission and medium voltage drive. Obviously, the current scalability is not so easy and straightforward and may hinder the system modularity.

The feasible current scalability options for modular multilevel converter MMC based on available design are given in FIG. 2. In FIG. 2, m identical arms A1 to Am in available design are connected in parallel to form an upper arm UA and to increase the current capacity by m. The lower arm LA can include the same or different structure as the upper arm UA with the same current capacity.

FIG. 2 shows the current scaling design for modular multilevel converter MMC. As explained, the parallel arms method can reuse the available SM design, thus having better current modularity.

In order to control the differential mode current between arms A1 to Am in the upper arm UA or the lower arm LA, two kinds of methods are proposed. The first method in FIG. 4A uses the extra current loop to generate the extra differential mode voltage reference component Δυₚₐⱼ*. Then each arm voltage reference could be obtained as,

$${v}_{paj}^{*} = {\overline{v}}_{pa}^{*} + Δ {v}_{paj}^{*} \qquad ( 1 )$$

In this way, the common current loop could be used to control each arm's current directly to get individual arm voltage reference υₚₐⱼ*.

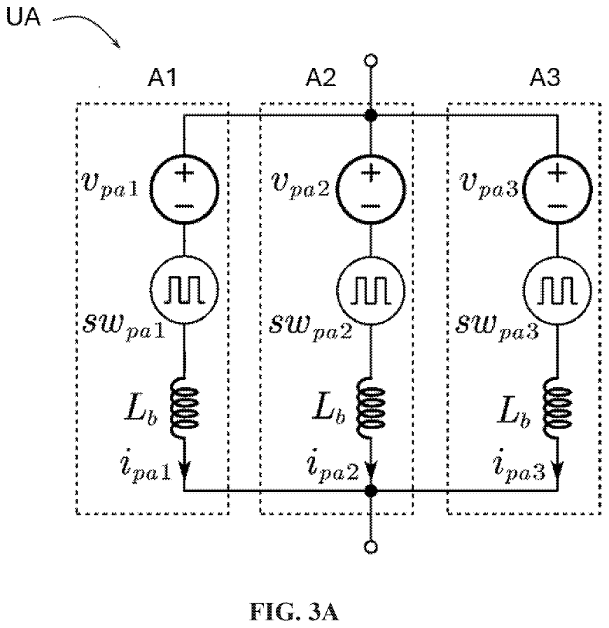

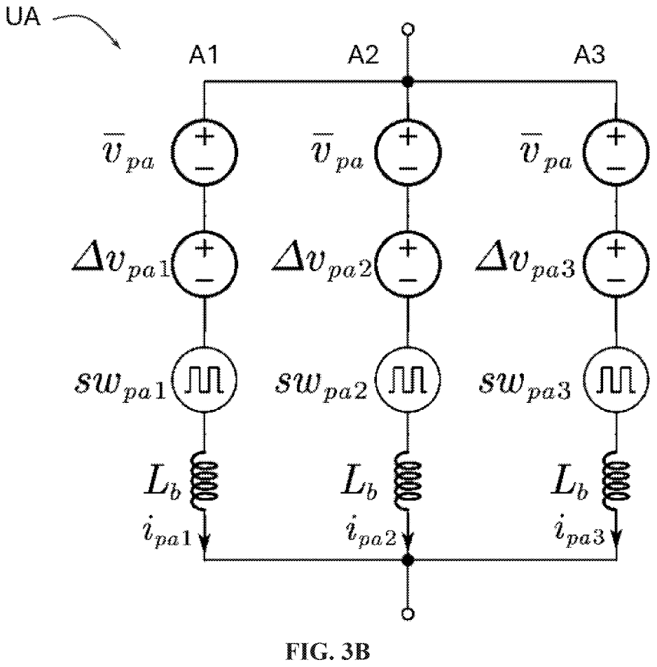

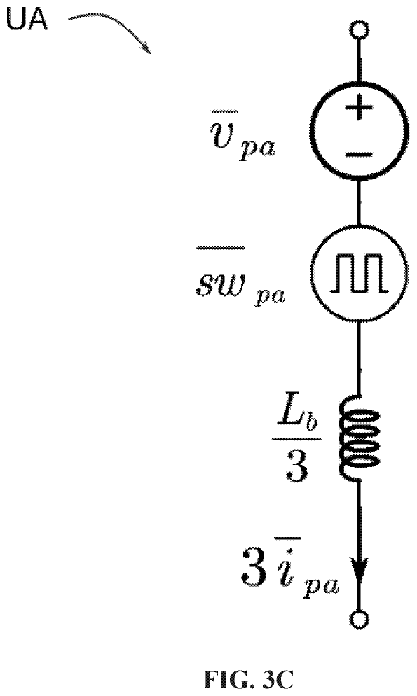

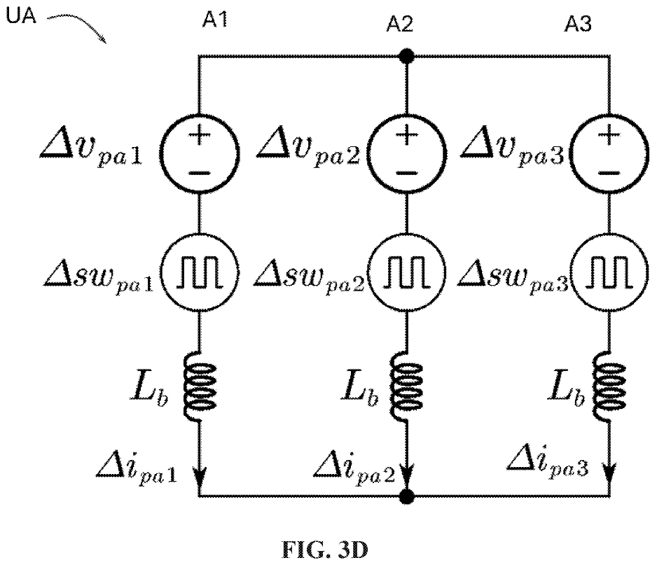

In detail, referring to FIG. 3A to FIG. 3D, FIG. 3A is a schematic representation of the simplified model of three parallel arms according to an embodiment of the disclosure. FIG. 3B is a schematic representation of the simplified model of three parallel arms with different voltage components according to an embodiment of the disclosure. FIG. 3C is a diagram illustration of the common-mode simplified model of three parallel arms according to an embodiment of the disclosure. FIG. 3D is a diagram illustration of the circulating simplified model of three parallel arms according to an embodiment of the disclosure. By using an average modeling method to lump the CL to a controlled voltage source υₚₐⱼ and equivalent switching frequency voltage source SWₚₐⱼ, the former can control the DC and AC side voltage or current, whereas the latter is the total equivalent switching frequency voltage of whole CL with the sum of magnitude of singe submodule DC-link voltage υ_{SMj}. Therefore, it determines the total harmonic distortion (THD) and quality of the arm current. Referring to the same process, three parallel arms can be replaced with three voltage sources υₚₐ₁, υₚₐ₂, υₚₐ₃, in a series connection with three switching frequency voltage source SWₚₐ₁, SWₚₐ₂, SWₚₐ₃ and three arm inductor L_{b} in FIG. 3A. Three arm currents are denoted as iₚₐ₁, iₚₐ₂, and iₚₐ₃ respectively. Referring to FIG. 3B and FIG. 3C, the average components can be defined below,

$${\overline{v}}_{pa} = \frac{1}{3} ( {v}_{pa 1} + {v}_{pa 2} + {v}_{pa 3} ) \qquad ( 2 )$$

$${\overline{𝒮𝒲}}_{pa} = \frac{1}{3} ( {𝒮𝒲}_{pa 1} + {𝒮𝒲}_{pa 2} + {𝒮𝒲}_{pa 3} )$$

$${\overline{𝒾}}_{pa} = \frac{1}{3} ( {𝒾}_{pa 1} + {𝒾}_{pa 2} + {𝒾}_{pa 3} )$$

Then referring to FIG. 3D, the differential mode voltage component could be defined as,

$$\{ \begin{matrix}Δ {v}_{pa 1} = {v}_{pa 1} - {\overline{v}}_{pa} \\ Δ {v}_{pa 2} = {v}_{pa 2} - {\overline{v}}_{pa} \\ Δ {v}_{pa 3} = {v}_{pa 3} - {\overline{v}}_{pa}\end{matrix} , \{ \begin{matrix}Δ {𝒮𝒲}_{pa 1} = {𝒮𝒲}_{pa 1} - {\overline{𝒮𝒲}}_{pa} \\ Δ {𝒮𝒲}_{pa 2} = {𝒮𝒲}_{pa 2} - {\overline{𝒮𝒲}}_{pa} \\ Δ {𝒮𝒲}_{pa 3} = {𝒮𝒲}_{pa 3} - {\overline{𝒮𝒲}}_{pa}\end{matrix} , \{ \begin{matrix}Δ {𝒾}_{pa 1} = {𝒾}_{pa 1} - {\overline{𝒾}}_{pa} \\ Δ {𝒾}_{pa 2} = {𝒾}_{pa 2} - {\overline{𝒾}}_{pa} \\ Δ {𝒾}_{pa 3} = {𝒾}_{pa 3} - {\overline{𝒾}}_{pa}\end{matrix} \qquad ( 3 )$$

In this way, the common-mode component of three parallel arms can be merged into a representative single arm as shown in FIG. 3C. The new arm includes the equivalent voltage sources υ̅ₚₐ and SWₚₐ, and the arm inductor L_{b}/3 with the arm current 3īₚₐ. As a result, the model of modular multilevel converter MMC with parallel arms is the same as the modular multilevel converter MMC with single arm.

Apart from the common-mode component, the differential mode component forms the circulating current paths for the parallel arms in FIG. 3D. The differential mode component Δυₚₐ₁, Δυₚₐ₂, Δυₚₐ₃ will not influence the current flowing through the total arm and only control the circulating current to balance the energy among parallel arms.

Energy balancing is important for the proper operation of modular multilevel converter MMC. High-level control, such as DC voltage control, total energy control, and upper-lower arm energy balancing can be used to generate the current reference iₚₐ* as shown in FIG. 4A and FIG. 4B. If m arms are connected in parallel, then each arm's current reference could be equally divided to ensure the current sharing.

$${𝒾}_{paj}^{*} = \frac{1}{m} {𝒾}_{pa}^{*} \qquad ( 4 )$$

An extra parallel energy balancing block can be implemented by controlling and injecting the differential mode current to each parallel arm.

$${P}_{paj} = ( {\overline{v}}_{pa}^{*} + Δ {v}_{paj} ) \cdot ( \frac{1}{m} {𝒾}_{pa}^{*} + Δ {𝒾}_{paj}^{*} ) \qquad ( 5 )$$

Therefore, the differential mode current reference could be generated through the PI control between the average arm energy and each arm energy.

$$Δ {𝒾}_{paj}^{*} = ( {K}_{p} + \frac{{K}_{i}}{s} ) ( \frac{1}{m} {\sum }_{j = 1}^{m} {\overline{v}}_{Cpaj} - {\overline{v}}_{Cpaj} ) \qquad ( 6 )$$

Where Kₚ and Kᵢ are the control parameters of the PI controller, respectively. υ̅_{Cpaj} is an average value of capacitor voltages of all submodules SM on one arm A1 to Am. It should be noted that other controllers can be used here as well.

Referring to FIG. 4A, optionally, the differential mode voltage reference value Δυₚₐⱼ* for each arm is obtained from an output of a current loop combining a differential mode current component Δiₚₐⱼ of each arm and a differential mode current reference value Δiₚₐⱼ* for each arm.

Optionally, the differential mode current reference value Δiₚₐⱼ* for each arm is obtained from an output of a proportional-integral (PI) controller.

Optionally, the control module CM further includes a parallel energy balancing block (not shown) configured to provide a differential mode voltage component Δυ_{Cpaj}=υ_{Cpaj}−υ̅_{Cpa} of each arm to the PI controller.

Optionally, the common mode voltage reference value υ̅ₚₐ* is obtained from an output of a current loop inputting a current reference value iₚₐ* of the upper arm UA.

Referring to FIG. 1A, FIG. 1B, FIG. 2, and FIG. 4B, One embodiment of the disclosure further provides a modular multilevel converter MMC, including: a phase leg PL including a upper arm UA and a lower arm LA connected in series, wherein the upper arm UA includes a plurality of arms A1 to Am connected in parallel, wherein one of the arms A1 to Am includes a chain link CL and an arm inductor AI connected in series, wherein the chain link CL includes a plurality of submodules SM connected in series, wherein each submodule SM includes a half-bridge circuit HB or a full-bridge circuit FB; and a control module CM connected to the plurality of submodules SM, wherein the control module CM is configured to provide a voltage reference value υₚₐⱼ* for each arm from an output of a current loop inputting a current reference value iₚₐⱼ* for each arm.

Referring to FIG. 4B, the main difference between this embodiment and the previous embodiment is the algorithm of the control module CM of this embodiment. In order to control the differential mode current between arms A1 to Am in the upper arm UA or the lower arm LA, two kinds of methods are proposed. The second method shown in FIG. 4B combines the differential mode current reference value Δiₚₐⱼ* with the common mode current reference

$$\frac{1}{m} {𝒾}_{pa}^{*}$$

to get the current reference of each parallel arm iₚₐⱼ*.

$${𝒾}_{paj}^{*} = \frac{1}{m} {𝒾}_{pa}^{*} + Δ {𝒾}_{paj}^{*} \qquad ( 7 )$$

In this way, the common current loop could be used to control each arm's current directly to get individual arm voltage reference υₚₐⱼ*.

Optionally, the current reference value iₚₐⱼ* for each arm is obtained by combining a common mode current reference value

$$\frac{1}{m} {𝒾}_{pa}^{*}$$

for each arm and a differential mode current reference value Δiₚₐⱼ* for each arm.

Optionally, the differential mode current reference value Δiₚₐⱼ* for each arm is obtained from an output of a proportional-integral (PI) controller.

Optionally, the control module CM further includes a parallel energy balancing block (not shown) configured to provide a differential mode voltage component Δυ_{Cpaj}=υ_{Cpaj}−υ̅_{Cpa} of each arm to the PI controller.

Optionally, the common mode current reference value

$$\frac{1}{m} {𝒾}_{pa}^{*}$$

for each arm is obtained by dividing a current reference value iₚₐ* of the upper arm UA with a number m of the arms in the upper arm UA.

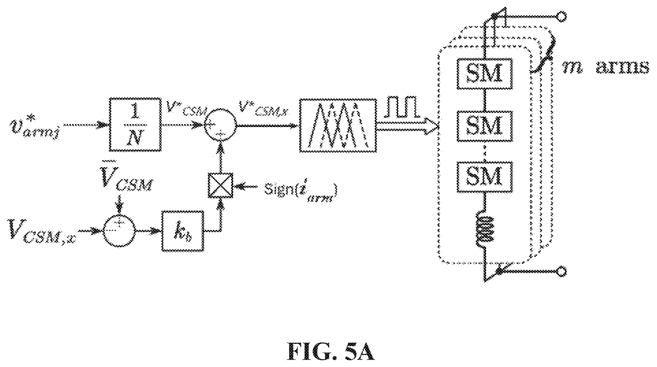

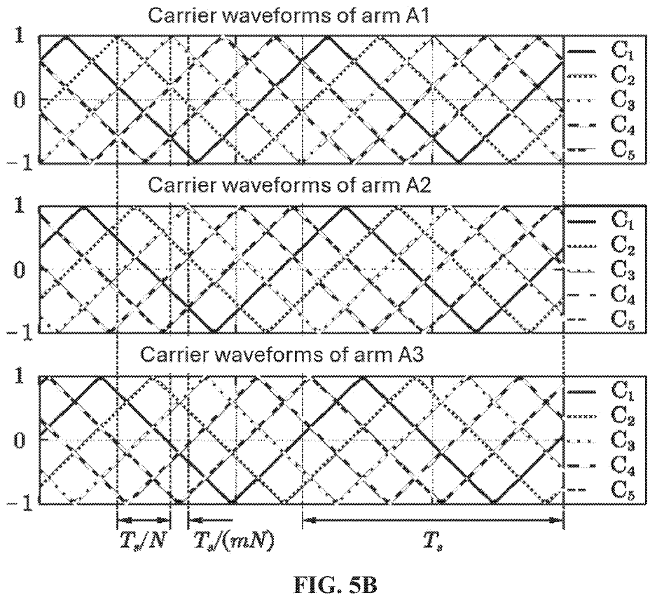

Referring to FIG. 1A, FIG. 1B, FIG. 2, FIG. 5A, and FIG. 5B, FIG. 5A is a diagram illustration of the phase-shift carrier-based modulation method for parallel arms according to an embodiment of the disclosure. FIG. 5B is a diagram illustration of the interleaved carrier waveform according to an embodiment of the disclosure. One embodiment of the disclosure further provides a modular multilevel converter MMC, including: a phase leg PL including a upper arm UA and a lower arm LA connected in series, wherein the upper arm UA includes a plurality of arms A1 to Am connected in parallel, wherein one of the arms A1 to Am includes a chain link CL and an arm inductor AI connected in series, wherein the chain link CL includes a plurality of submodules SM connected in series, wherein each submodule SM includes a half-bridge circuit HB or a full-bridge circuit FB; and a control module CM connected to the plurality of submodules SM, wherein the control module CM is modulated by a phase-shift method that carrier phases of submodules SM in the arm are interleaving, and carrier phases of arms are interleaving.

In detail, the carrier phase-shifted modulation (CPS-PWM) process of a modular multilevel converter MMC involves shifting the phase of a triangular carrier wave according to the number of submodules SM and comparing it with a reference wave to control the on/off state of each submodule SM. In FIG. 5B, period Tₛ of the carriers C₁ to C₅ are identical. Phase shift of carriers C₁ to C₅ in one arm is Tₛ/N. Phase shift of carriers C₁ between different arms is Tₛ/mN.

The average voltage source in each arm controls the voltage or current of medium-voltage alternating current (MVAC) and MVDC side, while the switching frequency harmonics are controlled by the switching frequency component SWₚₐ. If the same modulation stage is applied to parallel arms, there is no interleaving of the switching frequency component among each arm.

$${\overline{𝒮𝒲}}_{pa} = {𝒮𝒲}_{pa 1} = {𝒮𝒲}_{pa 2} = {𝒮𝒲}_{pa 3} \qquad ( 8 )$$

As a result, the switching frequency harmonic percentage of the total arm current will be the same as each parallel arm. It also means the differential mode current will not contain any switching frequency component theoretically.

On the contrary, interleaving among parallel arms is feasible to reduce the harmonics of total arm current by modifying the modulation stage. Two types of modulation methods are used as examples here, but interleaving can be applied to other modulation methods as well.

The carrier-based modulation method is shown in FIG. 5A. Supposing the phase-shift modulation method is applied inside each arm with N SMs, then the phase-shift angle is 2π/N. In order to interleave the arms, the carrier phase-shift angle of m parallel arms is defined as 2π/mN. The carrier waveforms with the example of N=5, m=3 are given in FIG. 5B.

Optionally, a capacitor voltage reference value υ_{CSM,x}* for each submodule SM in one of the arms is provided to the phase-shift method to determine which submodule SM is bypassed. In detail, to balance the capacitor voltages υ_{CSM,x} of each submodule SM and maintain them within a suitable range, during the current inflow phase (sign(iₐᵣₘ)>0), the submodule SM with the lower capacitor voltage can be turned on to charge it, and during the current outflow phase (sign (i arm)<0), the submodule SM with the higher capacitor voltage can be turned on to discharge it.

Optionally, the capacitor voltage reference value V_{CSM,x}* for each submodule SM in one of the arms is obtained by combining a common mode capacitor voltage reference value V_{CSM}*=

$$\frac{1}{N} {v}_{armj}^{*}$$

and differential mode capacitor voltage reference value for each submodule SM in one of the arms. K_{b} is an adjustable constant used to determine the rate of voltage balance convergence.

Optionally, in an upper arm UA, number of the plurality of arms connected in parallel is m, number of the submodule SM in the arm is N, a carrier phase-shift angle of N submodules SM in the arm is defined as 2π/N, and a carrier phase-shift angle of m parallel arms A1 to Am is defined as 2π/mN.

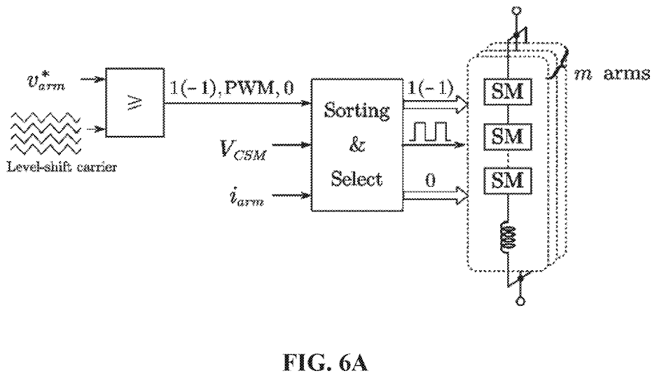

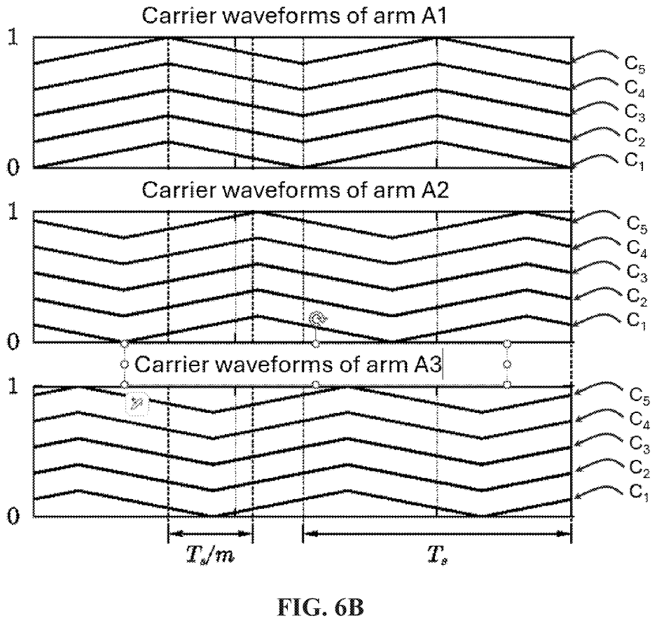

Referring to FIG. 1A, FIG. 1B, FIG. 2, FIG. 6A, and FIG. 6B, FIG. 6A is a diagram illustration of the level-shift sorting-based modulation method for parallel arms according to an embodiment of the disclosure. FIG. 6B is a diagram illustration of the interleaved level-shift carrier waveform according to an embodiment of the disclosure. One embodiment of the disclosure further provides a modular multilevel converter MMC, including: a phase leg PL including a upper arm UA and a lower arm LA connected in series, wherein the upper arm UA includes a plurality of arms A1 to Am connected in parallel, wherein one of the arms A1 to Am includes a chain link CL and an arm inductor AI connected in series, wherein the chain link CL includes a plurality of submodules SM connected in series, wherein each submodule SM includes a half-bridge circuit HB or a full-bridge circuit FB; and a control module CM connected to the plurality of submodules SM, wherein the control module CM is modulated by a level-shift method.

In detail, MMC Level-Shift PWM process of a modular multilevel converter MMC involves comparing a sinusoidal modulated signal (reference wave) with multiple vertically offset triangular carriers, each corresponding to a submodule SM. The comparison results control the on/off state of each submodule SM, achieving high-level output and balancing the voltages of each module.

If the sorting-based method is used in each arm as shown in FIG. 6A, the level-shift carrier is usually adopted to generate the working modes of insertion, bypass, and PWM. Then the phase angle of the carrier could be shifted among m parallel arms with the phase-shift angle of 2π/m. The carrier waveforms with the example of N=5, m=3 are given in FIG. 6B.

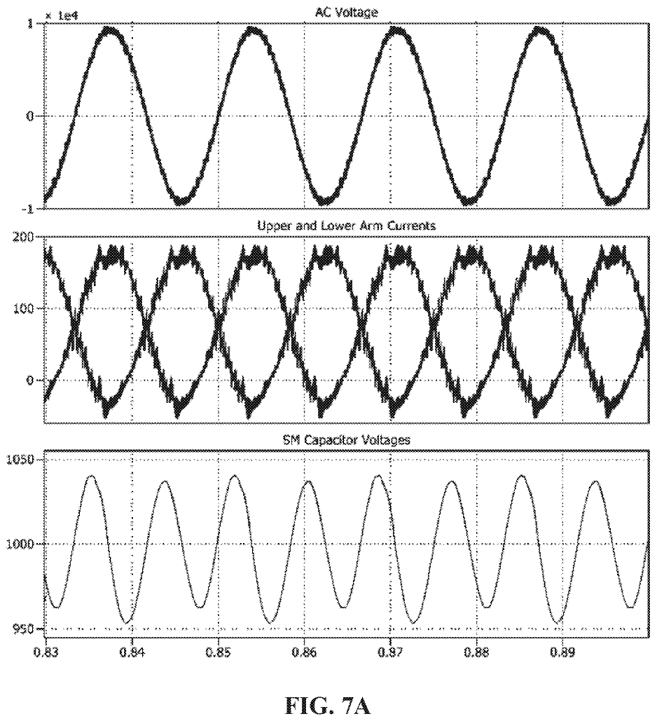

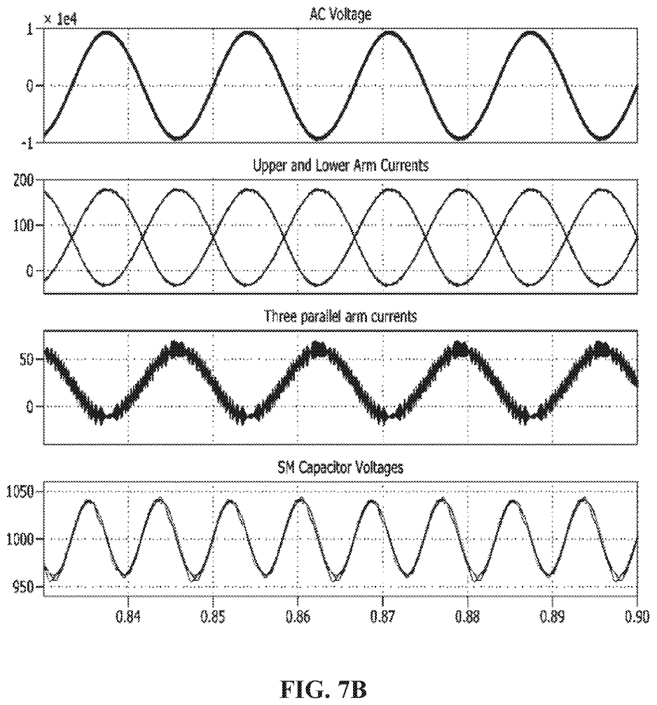

Referring to FIG. 7A and FIG. 7B, FIG. 7A is the simulation waveforms of MMC with only one arm according to an embodiment of the disclosure. FIG. 7B is the simulation waveforms of MMC with three parallel arms and the proposed energy control balancing method and interleaved modulation strategy according to an embodiment of the disclosure. FIG. 7A shows the results of the modular multilevel converter MMC with a single arm, while FIG. 7B shows the results of three parallel arms adopting the proposed parallel arm energy balancing and interleaving method. It can be observed that the switching frequency harmonics in the total arm current are reduced a lot. The SM capacitor voltages of three parallel arms are balanced as well.

Optionally, a capacitor voltage reference value V_{CSM,x}* for each submodule SM is provided to the level-shift method to determine which submodule SM is bypassed. In detail, V_{CSM} is an instantaneous measurement of the capacitor voltage of submodule SM. All capacitor voltage measurements are sorted according to the transient direction of the arm current iₐᵣₘ to assign different switching states to different submodules. To balance the capacitor voltages υ_{CSM,x} of each submodule SM and maintain them within a suitable range, during the current inflow phase (sign(iₐᵣₘ)>0), the submodule SM with the lower capacitor voltage can be turned on to charge it, and during the current outflow phase(sign(iₐᵣₘ)<0), the submodule SM with the higher capacitor voltage can be turned on to discharge it.

Optionally, in the upper arm UA, number of the plurality of arms connected in parallel is m, number of the submodule in the arm is N, a carrier phase-shift angle of m parallel arms is defined as 2π/m.

Optionally, the control module CM is configured that carrier phases of arms (arm 1 to arm 3 in FIG. 6B) are interleaving.

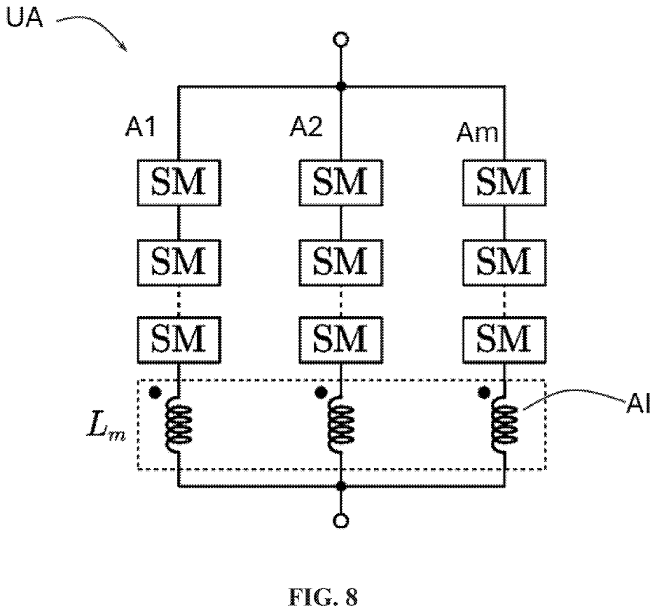

Referring to FIG. 8, FIG. 8 is a diagram illustration of three parallel arms with coupled inductors according to an embodiment of the disclosure. One embodiment of the disclosure further provides a modular multilevel converter MMC, including: a phase leg PL including a upper arm UA and a lower arm LA connected in series, wherein the upper arm UA includes a plurality of arms A1 to Am connected in parallel, wherein each of the arms A1 to Am includes a chain link CL and an arm inductor AI connected in series, wherein the chain link CL includes a plurality of submodules SM connected in series, wherein each submodule SM includes a half-bridge circuit HB or a full-bridge circuit FB, and wherein the arm inductors AI of each arm A1 to Am connected in parallel are coupling to each other.

One embodiment of the disclosure further provides a modular multilevel converter MMC according to any one of abovementioned embodiments, wherein the arm inductors AI of each arm A1 to Am connected in parallel are coupling to each other.

In addition to the individual arm inductor AI for each parallel arm, the coupled arm inductor AI can be used as shown in FIG. 8. Considering the symmetrical structure, the coupled inductor Lₘ can be defined in (9), where L is the self-inductance, and M is the mutual inductance. The mutual inductance could be designed to optimize the current quality and overall inductor volume.

$${L}_{m} = [ \begin{matrix}L & & M & … & M \\ M & & L & & M \\ & ⋮ & & ⋱ & ⋮ \\ M & & M & ⋯ & L\end{matrix} ] \qquad ( 9 )$$

Compared to prior art, the parallel arms of the embodiment of the disclosure can reuse the available SM design so that the power scaling of the MMC gets substantially facilitated. The control module of the embodiment of the disclosure provides close-loop control of current sharing and energy balancing control among the parallel arms. The SM capacitor voltages of the parallel arms are balanced as well. Further, the modulation stage of parallel arms could be interleaved to improve the current quality. Switching frequency harmonics in the total arm current are reduced a lot. Moreover, the coupled arm inductors of the embodiment of the disclosure optimize the total volume of arm inductors.

The above description is to illustrate the characteristics of the disclosure through preferred embodiments. The purpose is to enable those skilled in the art to understand the content of the disclosure and implement it accordingly, but not to limit the patent scope of the application. Therefore, any other equivalent modifications or modifications that do not depart from the technical ideas disclosed in this application shall still be included in the claim scope described below.

1. A modular multilevel converter, comprising:
a phase leg comprising a upper arm and a lower arm connected in series, wherein the upper arm comprises a plurality of arms connected in parallel, wherein one of the arms comprises a chain link and an arm inductor connected in series, wherein the chain link comprises a plurality of submodules connected in series, and wherein each submodule comprises a half-bridge circuit or a full-bridge circuit; and
a control module connected to the plurality of submodules, wherein the control module is configured to provide an electrical reference value for each arm by combining a common mode reference and a differential mode reference.

2.-20. (canceled)

21. The modular multilevel converter according to claim 1, wherein the control module is configured to provide a voltage reference value for each arm by combining a common mode voltage reference value for all of the arms and a differential mode voltage reference value for each arm.

22. The modular multilevel converter according to claim 21, wherein the differential mode voltage reference value for each arm is obtained from an output of a current loop combining a differential mode current component of each arm and a differential mode current reference value for each arm.

23. The modular multilevel converter according to claim 22, wherein the differential mode current reference value for each arm is obtained from an output of a proportional-integral (PI) controller, and the control module further comprises a parallel energy balancing block configured to provide a differential mode voltage component of each arm to the PI controller.

24. The modular multilevel converter according to claim 21, wherein the common mode voltage reference value is obtained from an output of a current loop inputting a current reference value of the upper arm.

25. The modular multilevel converter according to claim 1, wherein the control module is configured to provide a voltage reference value for each arm from an output of a current loop inputting a current reference value for each arm.

26. The modular multilevel converter according to claim 25, wherein the current reference value for each arm is obtained by combining a common mode current reference value for each arm and a differential mode current reference value for each arm.

27. The modular multilevel converter according to claim 26, wherein the differential mode current reference value for each arm is obtained from an output of a proportional-integral (PI) controller.

28. The modular multilevel converter according to claim 27, wherein the control module further comprises a parallel energy balancing block configured to provide a differential mode voltage component of each arm to the PI controller.

29. The modular multilevel converter according to claim 26, wherein the common mode current reference value for each arm is obtained by dividing a current reference value of the upper arm with a number of the arms in the upper arm.

30. A modular multilevel converter, comprising:
a phase leg comprising a upper arm and a lower arm connected in series, wherein the upper arm comprises a plurality of arms connected in parallel, wherein one of the arms comprises a chain link and an arm inductor connected in series, wherein the chain link comprises a plurality of submodules connected in series, wherein each submodule comprises a half-bridge circuit or a full-bridge circuit; and
a control module connected to the plurality of submodules, wherein the control module is modulated by a phase-shift method that carrier phases of submodules in the arm are interleaving, and carrier phases of arms are interleaving or the control module is modulated by a level-shift method.

31. The modular multilevel converter according to claim 30, wherein a capacitor voltage reference value for each submodule in one of the arms is provided to the phase-shift method to determine which submodule is bypassed.

32. The modular multilevel converter according to claim 31, wherein the capacitor voltage reference value for each submodule in one of the arms is obtained by combining a common mode capacitor voltage reference value and differential mode capacitor voltage reference value for each submodule in one of the arms.

33. The modular multilevel converter according to claim 30, wherein number of the plurality of arms connected in parallel is m, number of the submodule in the arm is N, a carrier phase-shift angle of N submodules in the arm is defined as 2π/N, and a carrier phase-shift angle of m parallel arms is defined as 2π/mN.

34. The modular multilevel converter according to claim 30, wherein a capacitor voltage reference value for each submodule is provided to the level-shift method to determine which submodule is bypassed when the control module is modulated by a level-shift method.

35. The modular multilevel converter according to claim 30, wherein number of the plurality of arms connected in parallel is m, number of the submodule in the arm is N, a carrier phase-shift angle of m parallel arms is defined as 2π/m when the control module is modulated by a level-shift method.

36. The modular multilevel converter according to claim 30, wherein the control module is configured that carrier phases of arms are interleaving when the control module is modulated by a level-shift method.

37. A modular multilevel converter, comprising:
a phase leg comprising a upper arm and a lower arm connected in series, wherein the upper arm comprises a plurality of arms connected in parallel, wherein each of the arms comprises a chain link and an arm inductor connected in series, wherein the chain link comprises a plurality of submodules connected in series, wherein each submodule comprises a half-bridge circuit or a full-bridge circuit, and wherein the arm inductors of each arm connected in parallel are coupling to each other.

38. The modular multilevel converter according to claim 30, wherein the arm inductors of each arm connected in parallel are coupling to each other.

39. The modular multilevel converter according to claim 1, wherein the arm inductors of each arm connected in parallel are coupling to each other.
